(19) United States
(12) Patent Application Publication
(10) Pub. No.: US 2013/0046596 A1
(43) Pub. Date: Feb. 21, 2013

(54) ADVERTISING SYSTEM AND METHOD FOR PROVIDING BENEFIT TO ADVERTISER AND ADVERTISER PROVIDING CASH BACK REWARDS IN VIEW OF TRANSACTION BETWEEN USER AND ADVERTISER

(71) Applicants: Hye Jung ROH, Seongnam-si (KR); Sungwook SEO, Seongnam-si (KR); Choong Hee LEE, Seongnam-si (KR)

(72) Inventors: Hye Jung ROH, Seongnam-si (KR); Sungwook SEO, Seongnam-si (KR); Choong Hee LEE, Seongnam-si (KR)

(73) Assignee: NHN Business Platform Corporation, Seongnam-si (KR)

(21) Appl. No.: 13/572,388

(22) Filed: Aug. 10, 2012

(30) Foreign Application Priority Data
Aug. 19, 2011 (KR) 10-2011-0082769

(51) Int. Cl. G06Q 30/02

(52) U.S. Cl. 705/14.21; 705/14.4; 705/14.23

(57) ABSTRACT

An advertising system and method for providing a benefit to an advertiser offering cash back rewards for a transaction with a user is provided. The advertising system may include an advertisement registration information receiving unit configured to receive advertisement registration information of an advertisement, a benefit condition verifying unit configured to verify whether the advertisement meets a determined advertiser benefit condition based on the advertisement registration information, and a benefit providing unit configured to provide an advertiser benefit when the advertisement meets the advertiser benefit condition.

### CROSS REFERENCE TO RELATED APPLICATION

This application claims priority from and the benefit of Korean Patent Application No. 10-2011-0082769, filed on Aug. 19, 2011, which is hereby incorporated by reference for all purposes as if fully set forth herein.

### BACKGROUND OF THE INVENTION

1. Field of the Invention

Exemplary embodiments of the present invention relate to a system and a method for providing benefit to an advertiser who offers cash back rewards for a transaction with a user.

2. Discussion of the Background

Conventionally, cash back rewards may be determined based on a transaction amount which may be a price of a purchased product or service provided by a transaction. Accordingly, cash back rewards may be generally proportional to a transaction amount of a purchase. When the same cash back rate of cash back rewards on a single transaction amount is applied to all products or services, the total cash back rewards may be linearly proportional to the total transaction amount. Although a cash back rate is applied to each product or service in a relatively different manner, the total cash back rewards may be approximately linearly proportional to the total transaction amount.

For example, a source of revenue for cash back rewards may correspond to a transaction amount in a conventional rewards managing method. Since a total amount of cash back rewards increases with an increase in the total transaction amount, a cash back rate of cash back rewards on a transaction amount may be provided on a fixed basis. In other words, according to a conventional rewards managing method, a cash back rate may be determined in advance of a product or service being sold, and the determined cash back rate may be provided to a user in advance.

However, when a source of revenue for cash back rewards does not correspond to a transaction amount, for example, when cash back rewards are provided for each transaction at a fixed rate but the total amount of cash back rewards is determined using additional parameters, it may be difficult to determine an amount of cash back rewards or a cash back rate on a total transaction amount. For example, when the total amount of cash back rewards is independent of a transaction amount, it may be difficult to determine an amount of cash back rewards or a cash back rate on a transaction amount.

In a conventional art, for example, Korean Patent Publication No. 10-2002-0060855 titled “An intermediary method of electronic commerce website” discloses that an intermediary website receives a predetermined amount of cash back rewards from an electronic commerce website and provides predetermined cash back rewards to a subscriber when the subscriber accesses the intermediary website through various means and purchases a product on the electronic commerce website through the intermediary website. Since a source of revenue for cash back rewards from the electronic commerce website is not a transaction amount, in this example it may be difficult to determine an amount of cash back rewards to be offered to a user.

Exemplary embodiments of the present invention provide a system and a method for effective management of cash back rewards in a case in which a source of revenue for cash back rewards is not a transaction amount.

The above information disclosed in this Background section is only for enhancement of understanding of the background of the invention and therefore it may contain information that does not form any part of the prior art nor what the prior art may suggest to a person of ordinary skill in the art.

### SUMMARY OF THE INVENTION

Exemplary embodiments of the present invention provide an advertising system and method for providing a benefit to an advertiser offering cash back rewards to a user in a case in which a source of revenue for cash back rewards is not a transaction amount but an advertising cost.

Exemplary embodiments of the present invention also provide an advertising system and method for providing an advertising cost discount benefit to an advertiser who offers cash back rewards to a user in a case in which a source of revenue for cash back rewards is not a transaction amount but an advertising cost.

Additional features of the invention will be set forth in the description which follows, and in part will be apparent from the description, or may be learned by practice of the invention.

Exemplary embodiments of the present invention provide an advertising system including an advertisement registration information receiving unit configured to receive advertisement registration information of an advertisement, a benefit condition verifying unit configured to verify the predetermined advertisement conditions based on the advertisement registration information, and a benefit providing unit configured to provide an advertiser benefit, wherein the advertisement registration information comprises at least one of information about an advertiser of the advertisement, information about an advertising cost of the advertisement, and information about a user benefit.

Exemplary embodiments of the present invention also provide a benefit providing method including receiving advertisement registration information of an advertisement, verifying a predetermined advertiser benefit condition for the advertisement based on the advertisement registration information, and providing an advertiser benefit when the advertisement meets the advertiser benefit condition wherein the advertisement registration information includes at least one information of information about an advertiser of the advertisement, information about an advertising cost of the advertisement, and information about a user benefit.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating a relationship between an advertiser, an advertising platform, a publisher, and a user, according to exemplary embodiments of the present invention.

FIG. 2 is a diagram illustrating a relationship between a member, an affiliate, and an advertising system, according to exemplary embodiments of the present invention.

FIG. 3 is a flowchart illustrating the accumulation and use of cash back rewards according to exemplary embodiments of the present invention.

FIG. 4 is a diagram illustrating an example of a website display providing an advertisement of an advertiser according to exemplary embodiments of the present invention.

FIG. 5 is a diagram illustrating another example of a website display providing an advertisement of an advertiser according to exemplary embodiments of the present invention.

FIG. 6 is a diagram illustrating an example of an order page of a website associated with an advertiser according to exemplary embodiments of the present invention.

FIG. 7 is a block diagram illustrating an internal configuration of an advertising system according to exemplary embodiments of the present invention.

FIG. 8 is a flowchart illustrating a benefit providing method according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element or layer is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, exemplary embodiments of the present invention are described in detail with reference to the accompanying drawings.

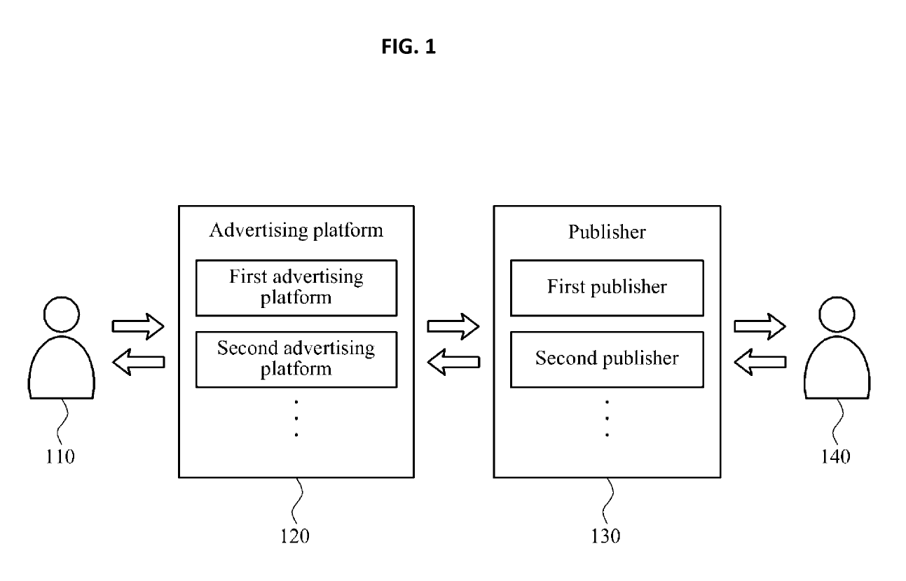

FIG. 1 is a diagram illustrating a relationship between an advertiser 110, an advertising platform 120, a publisher 130, and a user 140. The advertiser 110 and the user 140 may be terminals of the advertiser 110 and the user 140, for example, personal computers (PCs), portable electronic devices, smart televisions and smart phones. Arrows shown in FIG. 1 indicate data transmissions between a terminal of the advertiser 110, the advertising platform 120, the publisher 130, and a terminal of the user 140 via a wired/wireless network.

The advertising platform 120 may be a system that executes operations of advertisement bidding of the advertiser 110, matching advertisements and keywords, arranging advertisements or advertisers, providing advertisements to the publisher 130, and charging advertising costs. Since the general technical features of the advertising platform 120 can be understood by referring to a conventional search and/or banner advertising platform provided via an Internet, a detailed description is omitted herein for conciseness.

The term “publisher” may be used interchangeably with a “website” or may include the “website”. Further, the term “website” in the following description is not intended to limit the scope of the exemplary embodiments of the invention. The exemplary embodiments of the present invention may also be implemented in an environment other than an environment in which an application display is executed in a mobile terminal or a website is accessed by a PC. The term “website” may correspond to a publishing site or the publisher 130. For example, each website may correspond to an individual publisher. The “website” may include all forms of websites through which advertisements may be displayed and provided to users via a wired/wireless network, and may include one webpage constituting a website.

In the following description of the exemplary embodiments of the present invention, “displaying” of an advertisement may include providing a promotional content (e.g., text, images, sounds, videos, or hyperlinks) of a corresponding advertiser, to a website visitor via the corresponding website. Further, “selecting” of the displayed advertisement may mean that the user (website visitor) responds to the displayed promotional content of the advertiser by clicking on the promotional event to bring about an event intended to be achieved through the advertiser delivering the promotional content. The event intended to be achieved by the advertiser may include, for example, an event in which a webpage associated with the advertiser is displayed to the user selecting the advertisement.

The publisher 130 may provide a website of the publisher 130 to the user 140 and may provide a webpage constituting the website to the user 140 through the website or provide a search result for a keyword input through the web site to the user 140 using the keyword. The publisher 130 may receive an advertisement to be displayed or provided via the webpage from the advertising platform 120 and may provide the advertisement to the user 140. The publisher 130 may also transmit a keyword input by the user 140 to the advertising platform 120, and may receive an advertisement for the keyword from the advertising platform 120 and then provide the advertisement as part of a search result to the user 140.

The publisher 130 may provide a channel, for example, a display through which the user 140 is provided with an advertisement, and in a general online environment, may provide the advertisement through a website. A plurality of individual advertising platforms included in the advertising platform 120, for example, a first advertising platform and a second advertising platform, may display one or more advertisements through at least one of a plurality of individual publishers included in the publisher 130, for example, a first publisher, or a second publisher. Each of a plurality of individual publishers may provide at least one of the various services that may be provided via a wired/wireless network, for example, a unified search, a keyword search, or a blog service, to the user 140 through at least one website, in addition to displaying the advertisement.

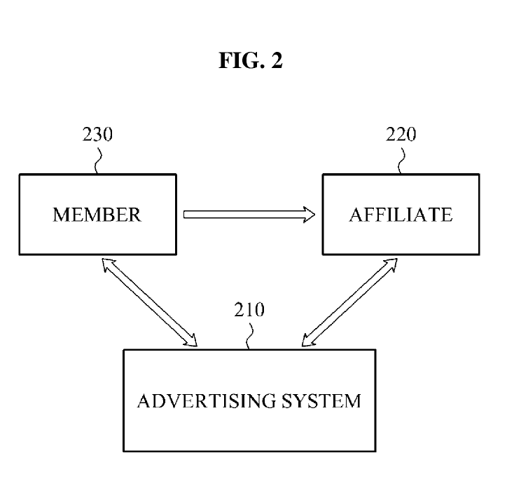

FIG. 2 is a diagram illustrating a relationship between a member 230, an affiliate 220, and an advertising system 210. The advertising system 210 may be included in or associated with a system of the advertising platform 120 or publisher 130 described through FIG. 1. For example, the affiliate 220 may be the advertiser 110 (of FIG. 1), who requests to become an affiliate through a website associated with the advertising system 210 and receives approval for the request. In some cases, the member 230 may be a user 140 (of FIG. 1), who completes a membership or subscription procedure through a website associated with the publisher. The website associated with the publisher 130 may include a website of the publisher 130 displaying information about an advertisement provided by the individual advertising platform 120. When the member 230 accesses a website of a publisher 130, visits an advertiser webpage through an advertisement of an advertiser 110 approved as an affiliate of the website of the publisher 130, and purchases a product or service on the advertiser webpage, the member 230 may be provided with cash back rewards determined based on a transaction amount. The transaction amount may correspond to an amount incurred by purchasing the product or service.

The term “cash back rewards” may be noted in terms of real monetary units, or may be noted in terms of points or accumulated mileage of electronic cash corresponding to the real monetary units. The electronic cash may be related to real currency (monetary unit) by a ratio, for example, 1:1 or 1:10. The ratio between electronic cash and real currency may change.

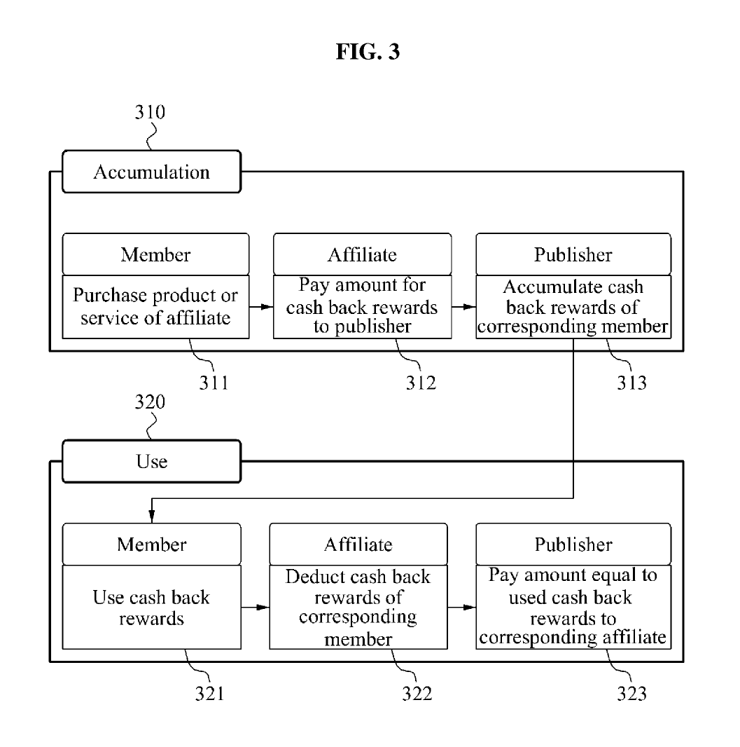

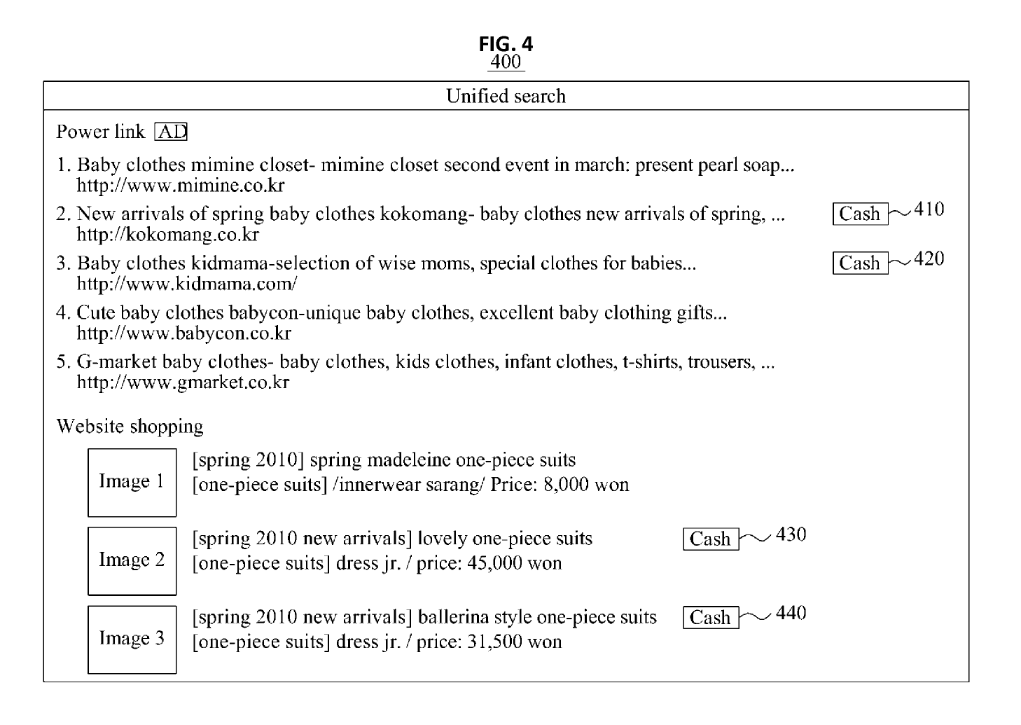

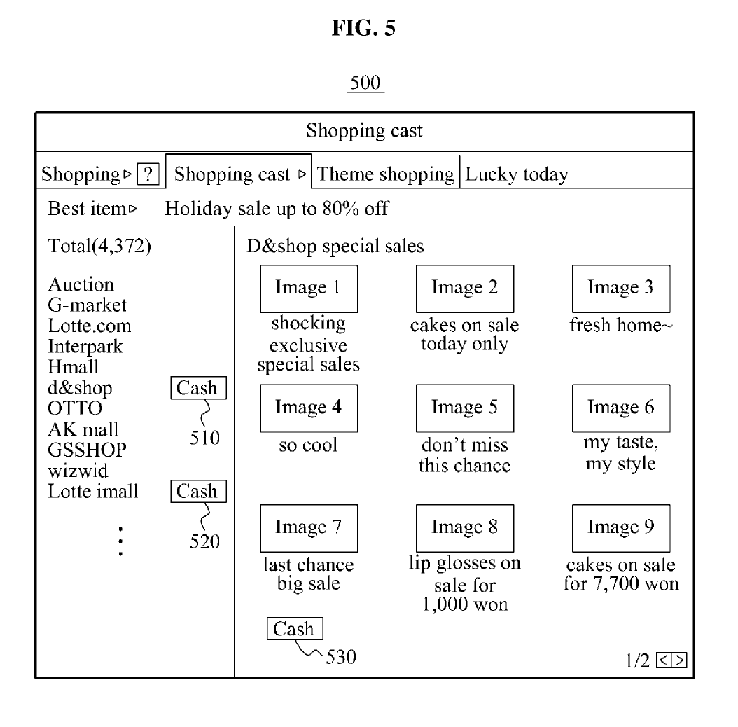

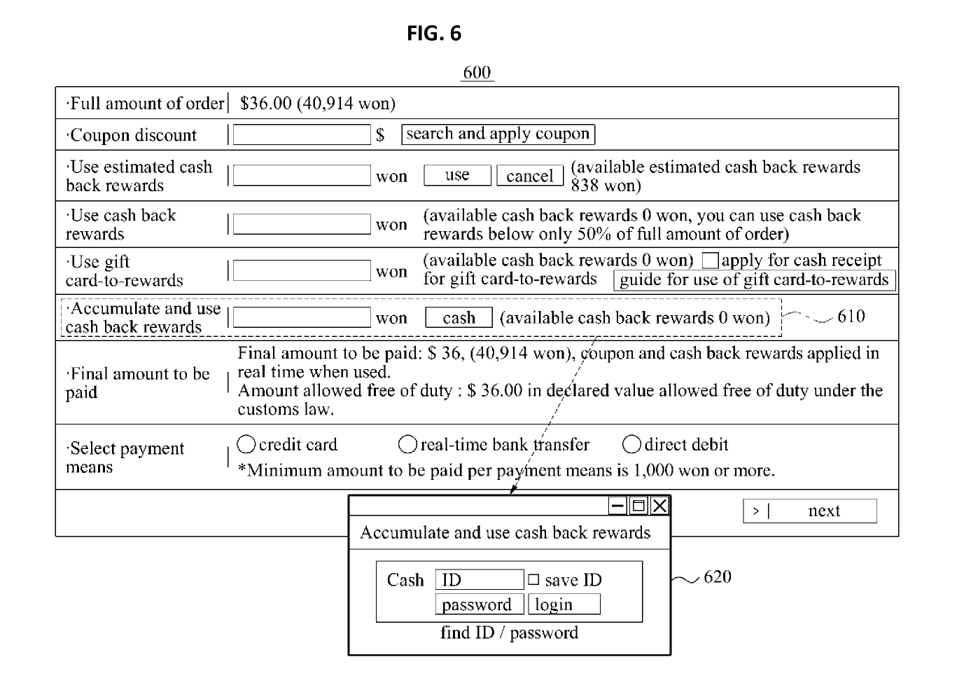

The advertising system 210 may provide a benefit to an advertiser 110 offering cash back rewards to a user 140. The advertising system 210 will be described later in further detail. Hereinafter, an operation of accumulating and using cash back rewards, an operation of indicating an affiliate, and a method for providing information relating to a cash back rate will be described with reference to FIG. 3, FIG. 4, FIG. 5, and FIG. 6.

FIG. 3 is a flowchart illustrating the accumulation and use of cash back rewards. In FIG. 3, an accumulation operation 310 and a use operation 320 are shown.

The accumulation operation 310 may include an operation 311 in which a member 230 purchases a product or service of an affiliate 220, an operation 312 in which the affiliate 220 pays an amount of cash back rewards to a publisher 130, and an operation 313 in which the publisher 130 accumulates the cash back rewards of the corresponding member 230. For example, when the member 230 accesses the advertisement of the affiliate 220 and purchases a product or service, the affiliate 220 may pay an amount for cash back rewards to the publisher 130 and the publisher 130 may store the cash back rewards accumulated by the corresponding member 230.

The use operation 320 may include an operation 321 in which the member 230 uses the cash back rewards, an operation 322 in which the publisher 130 deducts cash back rewards from the accumulated cash back rewards of the corresponding member 230, and an operation 323 in which the publisher 130 may pay an amount equal to the used cash back rewards to the corresponding affiliate 220. For example, when the member 230 uses a portion or all of the accumulated cash back rewards while purchasing a product or service of the affiliate 220, the publisher 130 deducts the redeemed cash back rewards of the member 230 and pays an amount equal to the redeemed cash back rewards to the corresponding affiliate 220.

FIG. 4 is a diagram illustrating an example of a website display providing an advertisement of an advertiser 110. A display 400 of FIG. 4 is part of a website (publisher) display on which advertisements of the advertiser 110 of FIG. 1 are displayed. Advertisements including “cash” icons 410, 420, 430, and 440 may be an advertisement for which user benefits, for example, cash back rewards are offered. For example, the “cash” icons 410, 420, 430, and 440 may be displayed for an advertisement of an advertiser 110 who is approved as an affiliate 220 allowing cash back rewards.

When the member 230 accesses a corresponding website via a hyperlink of an advertisement including one of the “cash” icon 410, 420, 430, and 440 and purchases a corresponding product or service, the member 230 may receive cash back rewards that may be proportional to a transaction amount.

FIG. 5 is a diagram illustrating a website display providing an advertisement of an advertiser 110. A display 500 of FIG. 5 is a portion of a website (publisher) display on which advertisements of the advertiser 110 are displayed. In the display 500, “cash” icons 510 and 520 may indicate that cash back rewards are set for all items of a shopping mall of a specific advertiser rather than for a product or a service. The “cash” icons 510 and 520 may indicate that cash back rewards are set for all products or services available for purchase via the shopping mall of the specific advertiser. Further, a “cash” icon 530 may indicate that cash back rewards are set for a product or a service corresponding to a product of image 7.

FIG. 6 is a diagram illustrating an order page of a website associated with an advertiser 110. A display 600 is a section of an order page for purchasing a product of a specific affiliate. A dotted box 610 shows an icon indicating that cash back rewards may be accumulated and a user interface to enable a user 140 to use the existing cash back rewards. For accumulation and use of cash back rewards, a login to a website associated with a publisher 130 may be requested. A log-in box 620 indicates a user interface for login to a website associated with a publisher 130. A user 140 may be identified as a member 230 by logging into a website associated with a publisher 130 using the log-in box 620.

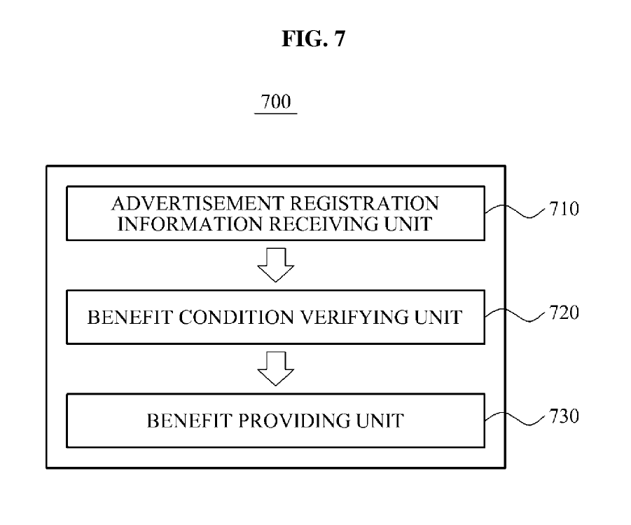

FIG. 7 is a block diagram illustrating an internal configuration of an advertising system 700. The advertising system 700 may be included in or linked to the system of the advertising platform 120 or publisher 130 described through FIG. 1, or may correspond to the advertising system 210 of FIG. 2. As shown in FIG. 7, the advertising system 700 may include an advertisement registration information receiving unit 710, a benefit condition verifying unit 720, and a benefit providing unit 730.

The advertisement registration information receiving unit 710 may receive advertisement registration information of an advertisement. The advertisement registration information may correspond to information registered about the advertisement, and may include, for example, at least one of information about an advertiser 110, information about an advertising cost, and information about a user benefit. The advertisement may include an advertisement displayed to a user 140 and an advertisement selected by the user 140 among advertisements displayed to the user 140. For example, the advertisement registration information receiving unit 710 may receive information registered about an advertisement displayed to the user 140 or an advertisement selected by the user 140, including information about an advertiser 110 of the advertisement, information about an advertising cost of the advertisement, and information about a user benefit. The user benefit may include cash back rewards offered to the user 140 when the user 140 purchases a product or service available for purchase on an advertising site of the advertisement.

The benefit condition verifying unit 720 may verify whether the advertisement meets a predetermined advertiser benefit condition based on the advertisement registration information. For example, the advertiser benefit condition may include at least one condition of an advertisement display condition in which the advertisement is displayed to the user 140, an advertisement selection condition in which the displayed advertisement is selected by the user 140, a visit inducing condition in which the user 140 is induced to visit an advertising site of the advertisement by selecting the displayed advertisement, an action condition in which the user 140 accesses the advertising site and executes an action intended to be achieved through the advertiser 110, and a user benefit condition in which a user benefit is provided to the user 140. The intended action may include at least one of signing-up to the advertising site and purchasing a product or service available for purchase on the advertising site.

The benefit condition verifying unit 720 may verify, based on the advertisement registration information, at least one of whether the advertisement is displayed to the user 140, whether the user 140 selects the displayed advertisement, whether the user 140 visits the advertising site through the selected advertisement, whether the user 140 signs up the advertising site after the user 140 visits the advertising site through the advertisement, and whether the user 140 purchases a product or service after the user 140 visits the advertising site.

The benefit providing unit 730 may provide an advertiser benefit when the advertisement meets the advertiser benefit condition. For example, the benefit providing unit 730 may provide the advertiser benefit by discounting an advertising cost of the advertiser 110. The advertising cost may include at least one of a cost per mille (CPM)-based advertising cost incurred by displaying the advertisement to the user 140, a cost per click (CPC)-based advertising cost incurred by the user 140 visiting the advertising site of the advertisement by selecting the displayed advertisement, and a cost per action (CPA)-based advertising cost incurred by the user 140 purchasing a product or service on the advertising site. The benefit providing unit 730 may provide the advertiser benefit to the advertiser 110 by discounting the advertising cost per display, per click, or per action.

The advertising cost may also include a total advertising cost calculated for the advertisement for a predetermined period. In this case, the benefit providing unit 730 may provide the advertiser benefit to the advertiser 110 by discounting the total advertising cost accumulated for a predetermined period, at a predetermined discount rate or by a predetermined discount amount.

The discount amount may be determined based on at least one of an advertising cost, a conversion rate, a click through rate (CTR), a number of displays, a number of clicks, a CPM, a CPC, a CPA, and in a case in which the user 140 purchases a product or service on the advertising site of the advertisement, a transaction amount, cash back rewards offered to the user 140 as the user benefit based on the transaction amount, a history of a ratio of provided cash back rewards to the transaction amount, an advertising effect, a number of purchases, and an industry profit margin.

The advertising system 700 may further include a vendor information verifying unit (not shown) to verify information about a vendor selling a product or service on an advertising page of the advertisement. When the advertiser 110 is identical to the vendor, the benefit providing unit 730 may provide the advertiser benefit to the advertiser 110, and when the advertiser 110 is not identical to the vendor, the benefit providing unit 730 may provide a benefit to the advertiser 110 or the vendor based on a subject offering the user benefit to the user 140 who purchases a product or service. For example, an advertiser 110 of a shopping mall advertisement may be different from a vendor selling a product or service in the shopping mall. When the subject offering the user benefit, for example, cash back rewards is the advertiser 110, the benefit providing unit 730 may provide an advertiser benefit to the advertiser 110, and when the subject is the vendor, may provide a vendor benefit to the vendor. The vendor benefit may be accumulated in association with a uniform resource locator (URL) of a website of the vendor and a name of the product or service that the vendor sells, and when the vendor becomes an advertiser 110 by displaying an advertisement of the vendor, may be provided to the vendor as an advertiser benefit.

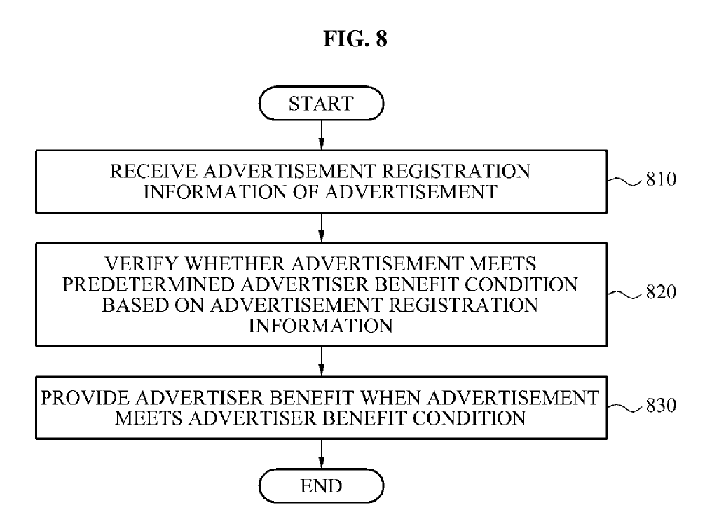

FIG. 8 is a flowchart illustrating a benefit providing method. The benefit providing method may be performed by the advertising system 700 of FIG. 7. In FIG. 8, the benefit providing method is described through each operation performed by the advertising system 700.

In operation 810, the advertising system 700 may receive advertisement registration information of an advertisement. The advertisement registration information may correspond to information registered about the advertisement, and may include, for example, at least one of information about an advertiser 110, information about an advertising cost, and information about a user benefit. The advertisement may also include an advertisement displayed to a user 140 and an advertisement selected by the user 140 among advertisements displayed to the user 140. For example, the advertising system 700 may receive information registered about an advertisement displayed to the user 140 or an advertisement selected by the user 140, including information about an advertiser 110 of the advertisement, information about an advertising cost of the advertisement, and information about a user benefit. The user benefit may include cash back rewards offered to the user 140 when the user 140 purchases a product or service available for purchase on an advertising site of the advertisement.

In operation 820, the advertising system 700 may verify whether the advertisement meets a predetermined advertiser benefit condition based on the advertisement registration information. The advertiser benefit condition may include at least one condition of an advertisement display condition in which the advertisement is displayed to the user 140, an advertisement selection condition in which the displayed advertisement is selected by the user 140, a visit inducing condition in which the user 140 is induced to visit an advertising site of the advertisement by selecting the displayed advertisement, an action condition in which the user 140 accesses the advertising site and executes an action intended to be achieved through the advertiser 110, and a user benefit condition in which a user benefit is provided to the user 140. The intended action may include at least one of sign-up to the advertising site and purchase of a product or service on the advertising site.

In operation 820, the advertising system 700 may verify, based on the advertisement registration information, at least one of whether the advertisement is displayed to the user 140, whether the user 140 selects the displayed advertisement, whether the user 140 visits the advertising site through the selected advertisement, whether the user 140 signs-up to the advertising site after visiting the advertising site through the advertisement, and whether the user 140 purchases a product or service after visiting the advertising site.

In operation 830, the advertising system 700 may provide an advertiser benefit when the advertisement meets the advertiser benefit condition. For example, the advertising system 700 may provide the advertiser benefit by discounting an advertising cost of the advertiser 110. The advertising cost may include at least one of a CPM-based advertising cost incurred by displaying the advertisement to the user 140, a CPC-based advertising cost incurred by the user 140 visiting the advertising site of the advertisement by selecting the displayed advertisement, and a CPA-based advertising cost incurred by the user 140 purchasing a product or service on the advertising site. The advertising system 700 may provide the advertiser benefit to the advertiser 110 by discounting the advertising cost per display, per click, or per action.

The advertising cost may also include a total advertising cost calculated for the advertisement, for a predetermined period. For example, the advertising system 700 may provide the advertiser benefit to the advertiser 110 by discounting the total advertising cost accumulated for a predetermined period, at a predetermined discount rate or by a predetermined discount amount.

The discount amount may be determined based on at least one of an advertising cost, a conversion rate, a CTR, a number of displays, a number of clicks, a CPM, a CPC, a CPA, and in a case in which the user 140 purchases a product or service on the advertising site of the advertisement, a transaction amount, cash back rewards offered to the user 140 as the user benefit based on the transaction amount, a history of a ratio of provided cash back rewards to the transaction, an advertising effect, a number of purchases, and an industry profit margin.

The advertising system 700 may further perform vendor information verification (not shown) to verify information about a vendor selling a product or service on an advertising page of the advertisement. For example, in operation 830, when the advertiser 110 is identical to the vendor, the advertising system 700 may provide the advertiser benefit to the advertiser 110, and when the advertiser 110 is not identical to the vendor, the advertising system 700 may provide a benefit to the advertiser 110 or the vendor based on a subject offering the user benefit to the user 140 who purchases a product or service. As another example, an advertiser 110 of a shopping mall advertisement may be different from a vendor selling a product or service in the shopping mall. When the subject offering the user benefit, for example, cash back rewards is the advertiser 110, the advertising system 700 may provide an advertiser benefit to the advertiser 110, and when the subject is the vendor, may provide a vendor benefit to the vendor. For example, the vendor benefit may be accumulated in association with a URL of a website of the vendor and a name of the product or service that the vendor sells, and when the vendor becomes an advertiser 110 by displaying an advertisement of the vendor, may be provided to the vendor as an advertiser benefit.

Hereinafter, an exemplary embodiment of the present invention in which an advertiser benefit is provided to an advertiser 110 offering cash back rewards to a user 140 who purchases a product or service on an advertising site that the user 140 visits through an advertisement provided, is described with reference to FIG. 2. The following description may also be applied to the advertising system 700 of FIG. 7 and the benefit providing method of FIG. 8.

When the member 230 visits a predetermined website, an advertisement of a registered advertiser may be provided or displayed to the member 230, and the member 230 may visit an advertising site by selecting, for example, clicking on the advertisement. For example, in a case in which the advertiser 110 joins an affiliate membership, the advertising site may correspond to the affiliate 220, and the member 230 visiting the advertising site may correspond to the member 230 visiting the affiliate 220. The advertising system 210 may verify whether the member 230 visiting the affiliate 220 purchases a product or service of the affiliate 220. For example, the advertising system 210 may verify whether the member 230 purchases a product or service of the affiliate 220 by verifying either whether a purchase of the product or service is completed or whether provision of cash back rewards on a transaction amount incurred by purchasing is completed. The advertising system 210 may verify, as needed, whether the member 230 purchases a product or service of the affiliate 220 by verifying both whether a purchase of the product or service is completed and whether provision of cash back rewards on a transaction amount incurred by purchasing is completed.

When it is verified that the member 230 purchases the product or service of the affiliate 220, the advertising system 210 may provide the advertiser benefit to the corresponding advertiser. The advertising system 210 may discount an advertising cost per click incurred by the member 230 selecting the advertisement.

For example, the advertising system 210 may discount an advertising cost per click by a discount amount determined using cash back rewards offered to members 230 on a transaction amount incurred by purchasing a product or service of an advertiser 110 for a predetermined period, a predetermined rate, and a number of clicks on an advertisement for the predetermined period. The discount amount may be calculated using the following Equation 1.

Discount amount=X*Y/A [Equation 1]

wherein ‘X’ denotes cash back rewards, ‘Y’ denotes a predetermined rate, and ‘A’ denotes a number of clicks. For example, an advertising cost discount budget available to the advertiser 110 may be determined using the cash back rewards ‘X’ offered to the members 230 on a last month or a last week and the predetermined rate ‘Y’. In this example, a discount amount per click may be calculated by dividing the advertising cost discount budget by the number of clicks ‘A’ on the last month or the last week.

The predetermined rate may be determined based on at least one of an advertising cost, an advertising effect, a number of purchases, a transaction amount incurred by purchasing, and an industry profit margin. A method of determining the predetermined rate may be applied to all predetermined rates that will be described hereinafter.

The advertising system 210 may discount an advertising cost per click by a discount amount determined using cash back rewards offered to the members 230 on a transaction amount incurred by purchasing a product or service of an advertiser 110 for a predetermined period, a predetermined rate, a number of clicks on an advertisement for the predetermined period, a CPC for the advertisement, and an average CPC for the advertisement. The discount amount may be calculated using the following Equation 2.

Discount amount=X*Y/A*C/B [Equation 2]

wherein ‘X’ denotes cash back rewards, ‘Y’ denotes a predetermined rate, ‘A’ denotes a number of clicks, ‘C’ denotes a CPC for the corresponding advertisement, and ‘B’ denotes an average CPC for the corresponding advertisement. For example, an advertising cost discount budget available to the advertiser 110 may be determined using the cash back rewards ‘X’ offered to the members 230 on a last month or a last week and the predetermined rate ‘Y’. In this example, a discount amount per click may be calculated by dividing the advertising cost discount budget by the number of clicks ‘A’ on the last month or the last week. The discount amount per click may also be calculated more accurately using a ratio of the CPC ‘C’ to an average CPC ‘B’ for the corresponding advertisement.

The advertising system 210 may discount an advertising cost per click by a discount amount determined using a CPC having a predetermined probability estimated based on a probability distribution, and a predetermined rate. The probability distribution may be estimated using a conversion rate for a predetermined period, a transaction amount incurred by purchasing a product or service of an advertiser 110 for a predetermined period, and a history of a ratio of provided cash back rewards to the transaction amount. This method of estimating the probability distribution may be applied to all probability distribution that will be described hereinafter. For example, the advertising system 210 may verify that a probability of occurrence of cash back rewards equal to or less than a CPC is 99% using the probability distribution. The advertising system 210 may determine the discount amount using the cost per click having a probability ‘Z’ and a predetermined rate ‘Y’. The discount amount may be calculated using the following Equation 3.

Discount amount=Z*Y [Equation 3]

The advertising system 210 may discount an advertising cost per click by a discount amount determined using a CPC calculated using a predetermined probability of occurrence based on a probability distribution, a predetermine rate, a CPC for the advertisement, and an average CPC for the advertisement. The advertising system 210 may determine the discount amount using a predetermined rate ‘Y’ and a CPC having a probability ‘Z’, and in this case, a discount amount per click may be calculated using a ratio of a CPC ‘C’ to an average CPC ‘B’ for the corresponding advertisement. The discount amount may be calculated using the following Equation 4.

Discount amount=Z*Y*C/B [Equation 4]

The advertising system 210 may also adjust the determined discount amount based on a quality index, and the quality index may be calculated based on at least one of a number of clicks on the advertisement, a number of times the advertisement is displayed, a number of purchases, a transaction amount incurred by purchasing, and an average display rank. The determined discount amount may be adjusted based on a quality of the advertisement. For example, the advertising system 210 may adjust up a discount amount for an advertisement having a high quality index and may adjust down a discount amount for an advertisement having a low quality index.

The discount amount may be unavailable when the advertising cost exceeds the cash back rewards.

Although the foregoing disclosure shows Equations 1 through 4 are used in a method of calculating a discount amount for discounting an advertising cost per click, the Equations 1 through 4 may also be used to calculate a discount amount for discounting an advertising cost per display or an advertising cost per conversion. For example, a discount amount for discounting an advertising cost per display or an advertising cost per conversion may be calculated by substituting a number of clicks ‘A’ with a number of displays or a number of conversions, a CPC ‘C’ with a cost per display or a cost per conversion, an average CPC ‘B’ with an average cost per display or an average cost per conversion, and a CPC having a probability ‘Z’ with a cost per display having a probability or a cost per conversion having a probability, respectively.

The advertising system 210 may also discount the advertising cost by deducting a predetermined discount amount from a total advertising cost accumulatively calculated for a predetermined period.

The advertising system 210 may also directly provide the discount amount to the advertiser 110. For example, in a case in which the advertising cost is deducted from a predetermined amount of electronic cash credited to the advertiser 110, the advertising system 210 may provide the advertiser benefit to the advertiser 110 by crediting the discount amount to the advertiser 110 in the form of electronic cash. The discount amount may be adjusted based on at least one of the advertising cost, a number of clicks on the advertisement, a number of times the advertisement is displayed, a number of purchases, a transaction amount incurred by purchasing, and an average display rank. The discount amount may be provided in the form of cash or points. The discount amount credited in the form of cash or points may be initially deducted when the advertising cost is incurred or points are used, and this benefit providing manner may be directly determined by the advertiser 110.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard discs, floppy discs, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to exemplary embodiments of the present invention, when a user 140 purchases a product or service of an advertiser 110 through a displayed advertisement of the advertiser 110 and pays for the product or service, cash back rewards may be provided to the user 140. Advertising effects of advertisers 110 as affiliate members 230 may be improved by providing cash back rewards to a user 140 who purchases a predetermined product or service or a product or services included in a predetermined website to attract interests from the user 140. In a corresponding medium, advertising profits may be earned by inducing interests of advertisers 110 due to improved advertising effects. Furthermore, in a case in which a source of revenue for cash back rewards is not a transaction but an advertising cost, an advertiser 110 offering cash back rewards to a user 140 may be provided with a benefit such as, for example, an advertising cost discount benefit.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An advertising system, comprising:
a storage device;
an advertisement registration information receiving unit configured to receive advertisement registration information of an advertisement, wherein the advertisement registration information is stored, at least in part, on the storage device;
a benefit condition verifying unit configured to verify whether the advertisement meets a determined advertiser benefit condition based on the advertisement registration information; and
a benefit providing unit configured to provide an advertiser benefit in response to determining that the advertisement meets the determined advertiser benefit condition,
wherein the advertisement registration information comprises at least one of information about an advertiser of the advertisement, information about an advertising cost of the advertisement, and information about a benefit.

2. The system of claim 1, wherein the determined advertiser benefit condition comprises at least one condition of an advertisement display condition in which the advertisement is displayed, an advertisement selection condition in which a displayed advertisement is selected, a visit inducing condition by which a visit to an advertising site of the advertisement by selecting a displayed advertisement is induced, an action condition by which the advertising site is accessed and an action intended to be achieved through the advertiser is executed, and a user benefit condition in which the benefit is provided.

3. The system of claim 1, wherein the user benefit comprises cash back rewards provided in response to a product or a service being purchased on the advertising site of the advertisement.

4. The system of claim 1, wherein the benefit providing unit is configured to determine a discount amount for the advertiser, and to provide the advertiser benefit by deducting the discount amount from the advertising cost of the advertiser or crediting the discount amount to the advertiser.

5. The system of claim 4, wherein the discount amount is deducted based on an advertising cost billing basis or a total advertising cost of the advertiser calculated for a determined period, and
the advertising cost billing basis corresponds to at least one basis for displaying the advertisement, a click on the displayed advertisement, and a purchase of the product or service of the advertiser.

6. The system of claim 4, wherein the discount amount is determined within a range of a budget set as at least a part of the benefit provided by the advertiser for a determined period.

7. The system of claim 4, wherein the discount amount is determined using a number of billing basis occurrences for a determined period, and one of an advertising cost per billing basis and an average advertising cost per billing basis.

8. The system of claim 4, wherein the discount amount is determined, based on an estimated value of the benefit to be provided per billing basis, to be a part of the estimated value, and
the estimated value of the benefit per billing basis is calculated based on a conversion rate for a determined period, a transaction amount per conversion, and a history of a ratio of the provided benefit to a transaction amount.

9. The system of claim 4, wherein the discount amount is differentially determined based on an advertising cost per billing basis.

10. The system of claim 1, wherein at least a part of the benefit provided by the advertiser is determined based on a determined rate, and
the determined rate is calculated based on at least one of the advertising cost, an advertising effect, a number of purchases of a product or a service of the advertiser, a transaction amount incurred by purchasing the product or the service, and an industry profit margin.

11. The system of claim 4, wherein the discount amount is adjusted by a quality index calculated based on at least one of a number of clicks on the advertisement, a number of times the advertisement is displayed, a number of conversions resulting from the advertisement, a number of purchases, a transaction amount incurred by purchasing, and an average display rank of the advertisement.

12. The system of claim 1, further comprising:
a vendor information verifying unit configured to verify information about a vendor selling a product or a service on an advertising page of the advertisement,
wherein the benefit providing unit is configured to provide the advertiser benefit to the advertiser when the advertiser is identical to the vendor, and when the advertiser is different from the vendor, to provide, based on a subject providing the benefit of the purchase of the product or the service, the advertiser benefit to the advertiser or to provide a vendor benefit to the vendor.

13. The system of claim 12, wherein the vendor benefit is accumulated in association with the vendor, and in response to an advertisement of the vendor being displayed, the vendor benefit is provided to the vendor as the advertiser benefit.

14. A benefit providing method using a processor, comprising:
receiving advertisement registration information of an advertisement;
verifying, by the processor, a determined advertiser benefit condition for the advertisement based on the advertisement registration information; and
providing an advertiser benefit in response to the advertisement meeting the advertiser benefit condition,
wherein the advertisement registration information includes at least one information of information about an advertiser of the advertisement, information about an advertising cost of the advertisement, and information about a benefit.

15. The method of claim 14, wherein the determined advertiser benefit condition comprises at least one condition of an advertisement display condition in which the advertisement is displayed, an advertisement selection condition in which a displayed advertisement is selected, a visit inducing condition by which a visit to an advertising site of the advertisement by selecting a displayed advertisement is induced, an action condition by which the advertising site is accessed and an action intended to be achieved through the advertiser is executed, and benefit condition in which the benefit is provided.

16. The method of claim 14, wherein the user benefit comprises cash back rewards provided in response to a product or a service being purchased on the advertising site of the advertisement.

17. The method of claim 14, wherein the providing of the advertiser benefit comprises:
determining a discount amount for the advertiser; and
providing the advertiser benefit by deducting the discount amount from the advertising cost of the advertiser or crediting the discount amount to the advertiser.

18. The method of claim 17, wherein the discount amount is deducted based on an advertising cost billing basis or a total advertising cost of the advertiser calculated for a determined period, and
the advertising cost billing basis corresponds to at least one basis for displaying the advertisement, a click on the displayed advertisement, and a purchase of the product or service of the advertiser.

19. The method of claim 14, further comprising:
verifying information about a vendor selling the product or the service on an advertising page of the advertisement,
wherein the providing of the advertiser benefit comprises providing the advertiser benefit to the advertiser when the advertiser is identical to the vendor, and when the advertiser is different from the vendor, providing, based on a subject providing the benefit of the purchase of the product or the service, the advertiser benefit to the advertiser or providing the vendor benefit to the vendor.

20. A non-transitory computer-readable recording medium comprising a program for instructing a computer to perform a benefit providing method using a processor, comprising:
receiving advertisement registration information of an advertisement;
verifying, by the processor, a determined advertiser benefit condition for the advertisement based on the advertisement registration information; and
providing an advertiser benefit in response to the advertisement meeting the advertiser benefit condition,
wherein the advertisement registration information includes at least one information of information about an advertiser of the advertisement, information about an advertising cost of the advertisement, and information about a benefit.
